(19) United States
(12) Patent Application Publication
(10) Pub. No.: US 2015/0293364 A1
(43) Pub. Date: Oct. 15, 2015

(54) BACKLIGHT MODULE AND 3D DISPLAY DEVICE

(71) Applicants: BOE TECHNOLOGY GROUP CO., LTD., Beijing (CN); BEIJING BOE CHATANI ELECTRONICS CO., LTD., Beijing (CN)

(72) Inventor: Sen CAO, Beijing (CN)

(21) Appl. No.: 14/315,752

(22) Filed: Jun. 26, 2014

(30) Foreign Application Priority Data
Apr. 15, 2014 (CN) 201410150664.6

(51) Int. Cl. G02B 27/22; G09G 5/10

(52) U.S. Cl. CPC G02B 27/22; G09G 5/10

(57) ABSTRACT

The present invention discloses a backlight module and a 3D display device. The backlight module comprises a backboard, and LED support frames positioned beneath the backboard for supporting LED lamps. A hollow structure is formed at a position on the backboard around corresponding LED lamp. The backlight module further comprises light condensing hoods corresponding to the LED lamps. The light condensing hood can passing through the hollow structure to stretch out or withdraw back. By condensing light of the LED lamp via the light condensing hood, a user can feel the contrast between strong light and weak light in a 3D display picture, so that the sense of reality of a 3D display device is enhanced; moreover, when all the light condensing hoods are stretched out from the backlight module, the 3D display device may become a searchlight, the practicability of the 3D display device is further enhanced.

### FIELD OF THE INVENTION

The present invention relates to the field of display technology, and particularly relates to a backlight module and a 3D display device.

### BACKGROUND OF THE INVENTION

With the emergence and development of 3D movies, more and more people hope to apply 3D technologies to intelligent terminals such as computers, TVs, mobile phones and the like.

At present, there are two types of 3D display technologies, one of which is glasses (polarized) 3D display, the other one is naked eye (parallax) 3D display. Specifically, the working principle of the glasses 3D display is as follows: a display panel receives a signal from a drive board and then displays two groups of pictures; when a person wears a pair of polarized glasses, the left eye receives one group of designated image, and the right eye receives another group of designated image; then, the human brain joins the two pictures together to form a stereoscopic image. The working principle of the naked eye 3D display is as follows: a display panel receives a signal from a drive board and displays two groups of designated pictures, a parallax plate in the display panel allows the left eye of a person to see only one group of designated picture and the right eye of the person to see only another group of designated picture, and then the human brain joins the two pictures together to form a stereoscopic image.

In the prior art, regardless of either the glasses 3D display or the naked eye 3D display, in consideration of the cost, protection to human eyes, suitability of human eyes and other factors, a light source generally provides light in a way of close-distance scattering, so that the quantity of light from the light source on each part of a display panel is equal.

FIG. 1 is a structural schematic diagram of a 3D display device in the prior art, and FIG. 2 is a sectional view of a backlight module in the prior art. As shown in FIG. 1 and FIG. 2, the 3D display device includes a display panel 1, an optical film layer 2 and a backlight module. The backlight module includes a backboard 4 and an LED lamp 5 positioned above the backboard 4. A reflective layer 3 is provided on the surface (other than the position of the LED lamp) and the peripheral area of the backboard 4. The LED lamp positioned on the backboard provides the display panel 1 with light for displaying pictures in a way of close-distance scattering.

However, when a user experiences sun or other dazzling pictures by the 3D display device in the prior art, the sense of reality of a picture is reduced because the quantity of light at each part of the picture is equal and the 3D display device does not emit any light beam.

### SUMMARY OF THE INVENTION

The present invention provides a backlight module, which condenses light of an LED lamp via a light condensing hood, so that a user may feel the contrast between strong light and weak light in a 3D display picture, and the sense of reality of a 3D display device is further enhanced.

To achieve the above object, the present invention provides a backlight module, including a backboard and an LED support frame positioned beneath the backboard for supporting LED lamps, a hollow structure being formed at a position on the backboard around a corresponding LED lamp, the backlight module further comprising light condensing hoods corresponding to the LED lamps, the light condensing hood being capable of passing through a corresponding hollow structure to stretch out or withdraw back.

Optionally, the backlight module further includes light condensing hood support frames, each of which being positioned beneath a corresponding light condensing hood for supporting the light condensing hood.

Optionally, the backlight module further includes power devices, each of which being positioned beneath a corresponding light condensing hood support frame and used for driving the light condensing hood support frame to ascend or descend, the ascent of the light condensing hood support frame driving the light condensing hood to stretch out from the upper surface of the backboard through the hollow structure, the descent of the light condensing hood support frame driving the light condensing hood to withdraw back to the beneath of the backboard through the hollow structure.

Optionally, the power device includes a power cylinder and a cylinder ejector pin, the power cylinder being connected to the cylinder ejector pin, the cylinder ejector pin being positioned beneath the light condensing hood support frame.

Optionally, the power device further includes a servo, the servo being connected to the power cylinder and used for controlling the operation of the power cylinder at a predetermined time so that the light condensing hood stretch out or withdraw back from the surface of the backboard.

Optionally, the servo is further used for receiving a digital signal sent by a mainboard of the 3D display device in real time, and controls the operation of the power cylinder according to the digital signal.

Optionally, the backlight module further includes a fixing plate, on which the power cylinders are fixed.

Optionally, the power device further includes an elastic unit, wherein the light condensing hood support frame passes through the LED support frame, and the elastic unit is positioned between the light condensing hood support frame and the LED support frame.

Optionally, a reflective film is provided on the inner wall of the light condensing hood.

Optionally, the light condensing hood is a frustum or hemisphere in shape.

To achieve the above object, the present invention further provides a 3D display device, including a backlight module. The backlight module employs the above backlight module.

The present invention has the following advantages.

The present invention provides the backlight module and the 3D display device, wherein the backlight module includes a backboard, an LED support frame and a light condensing hood, and the light condensing hood stretches out from the surface of the backboard through the hollow structure to condense light of the LED lamp. In the technical solutions of the present invention, by condensing light of the LED lamp via the light condensing hood, a user can feel the contrast between strong light and weak light in a 3D display picture, so that the sense of reality of a 3D display device is enhanced; meanwhile, when all the light condensing hoods stretch out from the backlight module, the 3D display device can also be used as a searchlight, so that the practicability of the 3D display device is further enhanced.

### BRIEF DESCRIPTION OF THE DRAWINGS

FIG. 1 is a structural schematic diagram of a 3D display device in the prior art;

FIG. 2 is a sectional view of a backlight module in the prior art;

FIG. 3 is a structural schematic diagram of a backlight module according to embodiment 1 of the present invention;

FIG. 4 is a schematic diagram of a backboard when a light condensing hood stretches out;

FIG. 5 is a schematic diagram of a hollow structure disposed on the backboard;

FIG. 6 is a sectional view when the light condensing hood corresponding to an LED lamp does not stretch out;

FIG. 7 is a sectional view when the light condensing hood corresponding to an LED lamp stretches out; and

FIG. 8 is a schematic diagram of real-time circuit signal control.

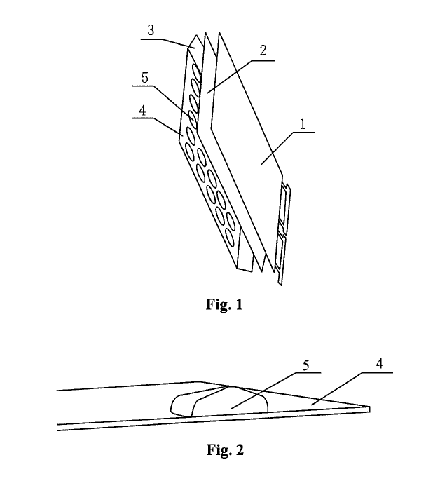

### DETAILED DESCRIPTION OF THE EMBODIMENTS

To make those skilled in the art better understand the technical solutions of the present invention, the backlight module and the 3D display device provided by the present invention will be described as below in details in conjunction with the accompanying drawings.

### Embodiment 1

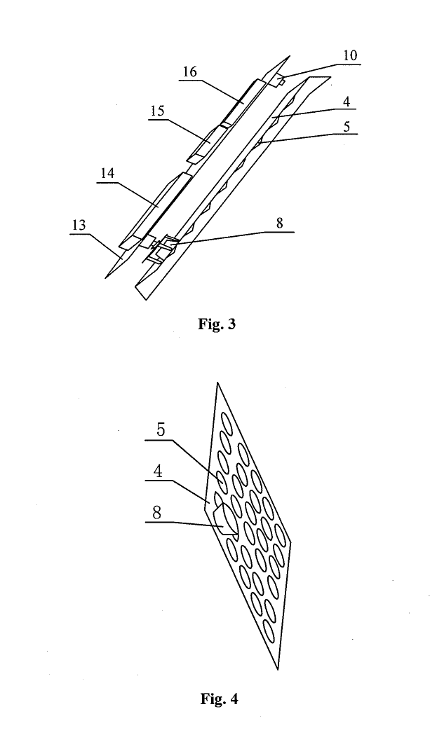

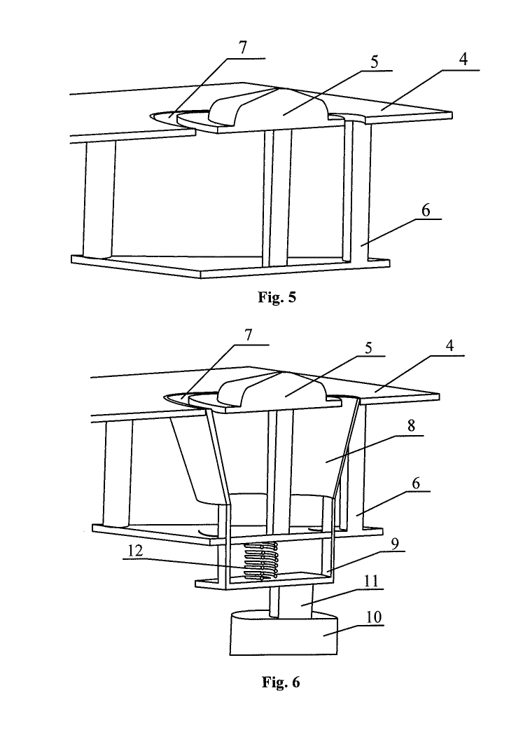

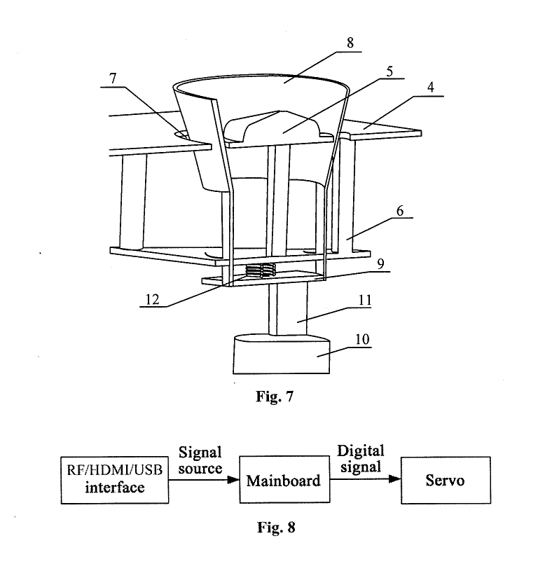

FIG. 3 is a structural schematic diagram of a backlight module according to embodiment 1 of the present invention, FIG. 4 is a schematic diagram of a backboard when a light condensing hood stretches out, FIG. 5 is a schematic diagram of a hollow structure disposed on the backboard, FIG. 6 is a sectional view when the light condensing hood corresponding to an LED lamp does not stretch out, and FIG. 7 is a sectional view when the light condensing hood corresponding to an LED lamp stretches out. As shown in FIGS. 3-7, the backlight module includes a backboard 4, LED support frames 6 and a light condensing hoods 8, wherein the LED support frame 6 is positioned beneath the backboard 4 for supporting the LED lamp 5. A hollow structure 7 is formed at positions on the backboard 4 around the LED lamps 5. The light condensing hoods 8 stretch out or withdraws back through the hollow structure. When stretching out from the surface of the backboard 4 through the hollow structure 7, the light condensing hood 8 may play a role of condensing light of the LED lamp 5. The light condensing hood 8 may be made of metal or plastics.

When the 3D display device displays the sun and other dazzling pictures, the light condensing hood 8 corresponding to a dazzling area stretches out from the surface of the backboard 4 to condense light of the LED lamp 5 within the dazzling area. Under the action of the light condensing hood 8, light of the dazzling area becomes a long-distance direct-illuminating from the close-distance scattering, so that the effect of the brightness of light of the dazzling area being higher than other areas can be realized, and the sense of reality of a picture of the 3D display device is further enhanced.

It is to be noted that, to be illustrative, the light condensing hood is only drawn at the position of an LED lamp on the backboard. In practical applications, a hollow structure and a light condensing hood are correspondingly disposed at positions of a part of or all of LED lamps on the backboard.

In this embodiment, to further enhance the light condensing effect of the light condensing hood 8, the light condensing hood 8 may be designed to be a frustum or hemisphere in shape, and a reflective film is provided on the inner wall of the light condensing hood 8. By using the above structure, light generated by the LED lamp can be emitted in a certain direction, thereby achieving the purpose of condensing light.

Referring to FIG. 6 and FIG. 7, the backlight module further includes a light condensing hood support frame 9 and a power device, wherein the light condensing hood support frame 9 is positioned beneath the light condensing hood 8 for supporting the light condensing hood 8. The power device is positioned beneath the light condensing hood support frame 9 for driving the light condensing hood support frame 9 to ascend or descend. The ascent of the light condensing hood support frame 9 drives the light condensing hood 8 to stretch out from the upper surface of the backboard 4 through the hollow structure 7. The descent of the light condensing hood support frame 9 drives the light condensing hood 8 to withdraw back to the beneath of the backboard 4 through the hollow structure 7.

In this embodiment, the power device specifically includes a power cylinder 10 and a cylinder ejector pin 11. The power cylinder 10 is connected to the cylinder ejector pin 11. The cylinder ejector pin 11 is positioned beneath the light condensing hood support frame 9, and fixed to the light condensing hood support frame 9. When the power cylinder 10 drives the cylinder ejector pin 11 to ascend, the cylinder ejector pin 11 pushes the light condensing hood 8 to ascend, so that light of the LED lamp 5 is condensed; and, when the power cylinder 10 drives the cylinder ejector pin 11 to descend, the cylinder ejector pin 11 drives the light condensing hood 8 to descend, so that close-distance scattering of the LED lamp is realized. To install the power cylinder 10, in this embodiment, a fixing plate 13 is also provided behind the backboard 4, and the power cylinder 10 is fixed on the fixing plate 13.

As another optional solution, the power device in this embodiment further includes an elastic unit 12. The light condensing hood support frame 9 passes through the LED support frame 6, and the elastic unit 12 is disposed between the light condensing hood support frame 9 and the LED support frame 6. At this time, the cylinder ejector pin 11 is not fixed to the light condensing hood support frame 9. When the power cylinder 10 drives the cylinder ejector pin 11 to ascend, the cylinder ejector pin 11 pushes the light condensing hood 8 to ascend, so that light of the LED lamp 5 is condensed, at this time, the elastic unit 12 between the light condensing hood support frame 9 and the LED support frame 6 is compressed; and, when the power cylinder 10 drives the cylinder ejector pin 11 to descend, the light condensing hood support frame moves downward under the elasticity of the elastic unit 12 because the elastic unit 12 is in a compressed state, and the light condensing hood support frame 9 drives the light condensing hood 8 to descend, wherein optionally, the elastic unit 12 is a spring.

In this embodiment, to coordinate with the 3D display device to display dazzling beams at a particular position in a particular picture and to improve the intelligence of the 3D display device, a servo 14 may be provided in the power device. The servo 14 is connected with the power cylinder 10 and used for controlling the operation of the power cylinder at a predetermined time, so as to allow the light condensing hood 8 at a particular position to stretch out or withdraw back from the surface of the backboard 4 at the predetermined time, so that the 3D display device displays or does not display the dazzling beams at the particular position in the particular picture. As another optional solution, the servo in the present invention may be further used for receiving a digital signal sent by a mainboard of the 3D display device in real time, and controls the operation of the power cylinder according to the digital signal, so that the real-time control of the servo to the light condensing hood is realized.

The principle of the servo controlling the ascent and descent of the light condensing hood in real time in the present invention will be described as below briefly with reference to the accompanying drawings. FIG. 8 is a schematic diagram of circuit signal control. As shown in FIG. 8, a control signal is added into a signal source of the 3D display device. The signal source is input into the mainboard 15 via an RF/HDMI/USB or other ports. The mainboard 15 performs A/D processing on the signal source to generate a corresponding digital signal and then sends the same to the servo 14. The servo 14 controls the operation of each power cylinder 10 on the fixing plate 13 according to the digital signal so as to realize the ascent or descent of the light condensing hood 8 at the particular position in the backlight module.

It is to be noted that, the servo 14, a power supply 16 for independently providing electric energy to the power cylinders 10, the mainboard 15 and other board cards may be all fixed on a surface of the fixing plate 13 opposite to the power cylinder 10, so that the integration level of the backlight module may be improved effectively, and the space is saved.

In the backlight module provided by embodiment 1 of the present invention, the backlight module includes a backboard, LED support frames and light condensing hoods, wherein the LED support frame is positioned beneath the backboard for supporting the LED support frame of the correponding LED lamp, a hollow structure is formed at a position corresponding to the LED lamp on the backboard, and the light condensing hood stretches out from the backboard through the hollow structure to condense light of the LED lamp. In the technical solutions of the present invention, by condensing light of the LED lamp via the light condensing hood, a user can feel the contrast between strong light and weak light in a 3D display picture, so that the sense of reality of a 3D display device is enhanced.

### Embodiment 2

Embodiment 2 of the present invention provides a 3D display device, including a backlight module. The backlight module employs the backlight module in embodiment 1, specifically refers to the description in embodiment 1 and will not be repeated here.

However, as the backlight module in the 3D display device has a function of condensing light of an LED lamp, specifically, the 3D display device may be used as a searchlight when all the light condensing hoods in the backlight module stretch out. When the 3D display device is disposed at a square or other public places, the occupied land is saved, the cost of purchase is reduced, and the 3D display device may be used for emergency, so that the practicability of the 3D display device is further enhanced.

In the 3D display device provided by embodiment 2 of the present invention, the 3D display device includes a backlight module, the backlight module includes a backboard, LED support frames and light condensing hoods, and the light condensing hood stretches out from the surface of the backboard through a hollow structure to condense light of the corresponding LED lamp. In the technical solutions of the present invention, by condensing light of the LED lamp via the light condensing hood, a user can feel the contrast between strong light and weak light in a 3D display picture, so that the sense of reality of the 3D display device is enhanced; moreover, the 3D display device provided by this embodiment has a function of searchlight, so that the practicability of the 3D display device is further enhanced.

It will be appreciated that, the foregoing embodiments are exemplary embodiments merely for describing the principle of the present invention, but the present invention is not limited thereto. A person of ordinary skill in the art may make various variations and improvements without departing from the spirit and essence of the present invention. However, these modifications and improvements are considered to be within the protection scope of the present invention.

1. A backlight module, comprising a backboard and LED support frames positioned beneath the backboard for supporting LED lamps, a hollow structure being formed at a position on the backboard around a corresponding LED lamp, the backlight module further comprising light condensing hoods corresponding to the LED lamps, the light condensing hood being capable of stretching out or withdrawing back through the corresponding hollow structure.

2. The backlight module according to claim 1, further comprising light condensing hood support frames positioned beneath a corresponding light condensing hood for supporting the light condensing hood.

3. The backlight module according to claim 2, further comprising power devices, each of which being positioned beneath a corresponding light condensing hood support frame and used for driving the light condensing hood support frame to ascend or descend, the ascent of the light condensing hood support frame driving the light condensing hood to stretch out from the upper surface of the backboard through the hollow structure, the descent of the light condensing hood support frame driving the light condensing hood to withdraw back to the beneath of the backboard through the hollow structure.

4. The backlight module according to claim 3, wherein the power device comprises a power cylinder and a cylinder ejector pin, the power cylinder being connected to the cylinder ejector pin, and the cylinder ejector pin being positioned beneath the light condensing hood support frame.

5. The backlight module according to claim 4, wherein the power device further comprises a servo, the servo being connected to the power cylinder and used for controlling the operation of the power cylinder at a predetermined time so that the light condensing hood is allowed to stretch out or withdraw back from the surface of the backboard.

6. The backlight module according to claim 5, wherein the servo is further used for receiving a digital signal sent by a mainboard of the 3D display device in real time, and controls the operation of the power cylinder according to the digital signal.

7. The backlight module according to claim 4, further comprising a fixing plate on which the power cylinders are fixed.

8. The backlight module according to claim 4, wherein the power device further comprises an elastic unit, the light condensing hood support frame passing through the LED support frame, and the elastic unit being positioned between the light condensing hood support frame and the LED support frame.

9. The backlight module according to claim 1, wherein a reflective film is provided on the inner wall of the light condensing hood.

10. The backlight module according to claim 1, wherein the light condensing hood is a frustum or hemisphere in shape.

11. A 3D display device, comprising the backlight module according to claim 1.
